(19) United States
(12) Patent Application Publication
(10) Pub. No.: US 2010/0138003 A1
(43) Pub. Date: Jun. 3, 2010

(54) Automation Component for an Industrial Automation Arrangement and Method for Activating an Operational State

(75) Inventors: Joachim August, Numberg (DE); Norbert Brousek, Furth (DE); Oliver Jõhssen, Erlangen (DE); Joachim Ohlmann, Herzogenaurach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/625,070

(22) Filed: Nov. 24, 2009

(30) Foreign Application Priority Data
Nov. 28, 2008 (EP) 08 020 698

(51) Int. Cl. G06F 1/32; G05B 11/01

(52) U.S. Cl. 700/22; 700/11

(57) ABSTRACT

An automation component for an industrial automation arrangement, wherein the automation component is configured to control at least one system part, process or subprocess of the industrial automation arrangement. At least two different operating states are able to be alternately set for the at least one system part, process or subprocess, and the operational states which differ with respect to the respective power consumption of the system part, process or subprocess. The automation component is configured to receive requests for a changeover to one of the at least two different operational states, the automation component is configured to output acknowledgement messages in response to the requests, and the automation component is configured to output status messages relating to the activated operating state of the operational states.

### BACKGROUND OF THE INVENTION

1. Field of the Invention

The present invention relates to automation components and, more particularly, to an automation component for an industrial automation arrangement and to a method for activating an operational state of the automation component.

2. Description of the Related Art

Usually, industrial automation arrangements comprise a multiplicity of automation components that are connected to one another by a data network, such as a field bus system. The automation components comprise, for example, sensors and actuators, where the actuators are particularly used to control industrial processes, subprocesses of industrial processes, production systems or the like. The automation components also include control devices, such as CPUs and controllers, which are used to process the signals detected by the sensors in a program-controlled manner, and to control a production system, another process or subprocess by driving the actuators. In addition, central components of an industrial automation arrangement are, for example, superordinate controllers, such as Manufacturing Execution Systems (MES), central power supplies and energy management systems, observation and operating workstations, databases, communication means and gateways.

A central task when controlling industrial production or an industrial process is to handle the available resources as economically as possible, in particular to minimize the consumption of (usually electrical) energy. It is therefore possible, for example, to switch off system parts which are temporarily not required by using the corresponding automation components, or to change the system parts to a standby mode. This may be performed, for example, manually or in a time-controlled manner in operational pauses, at night or on Sundays/holidays.

In addition to the requirement to reduce the total energy consumption of an automation arrangement, such as by implementing energy-saving measures, it is desirable to reduce the so-called peak load, i.e., the maximum energy consumption in an observation period. The reason for this, inter alia, is that the tariff models of energy suppliers in the industrial sector calculate higher tariffs for the electrical energy used at peak load than for a “base load” which remains the same. In addition, the technical devices used to distribute and supply energy have to be operated within their operating limits, with the result that peak loads that exceed these operating limits must be avoided. In industrial automation arrangements, when a peak load situation arises, it is therefore customary to temporarily switch off those automation components and, thus, those “loads” in which temporary switching-off does not have a negative influence on industrial production, the industrial production process or the like, or at least does not constitute a safety risk.

The foregoing strategy is also referred to as “peak-load-controlled load shedding”. For example, electrical heating systems that are intended to maintain a medium at a particular temperature in a storage container can, thus, be switched off, as long as the temperature of the medium does not fall to or below a minimum value. In another example, pumps for filling storage containers can be temporarily switched off or their delivery rate can be reduced, as long as the filling level of the storage container does not fall to or below a minimum value. A corresponding situation applies to wastewater pumps.

In each of the above examples, the automation components and the devices controlled by the latter are temporarily switched off or “stepped down”, either manually or in an automated manner by a control device. A disadvantage with manual control is that the person performing the control operation must have accurate knowledge of the operating limits, such as minimum filling levels and minimum temperatures, the current operating state, such as filling level, temperature, and the possible operating states (i.e., on, off, standby, partial load and/or full load), and the associated energy consumption of the individual automation components. Moreover, the operator must relate these details to a status of the entire automation arrangement, usually the current total energy consumption, and associated operating limits, such as peak load allowed, which imposes a high demand on the knowledge of the process to be controlled overall and of the individual subprocesses and the associated automation components.

Similar demands are also imposed on automatic control, which likewise must take into account both the states and operating limits of the individual automation components, as well as the states and operating limits of the entire process to be controlled and thus the entire industrial automation arrangement. Accordingly, there is a high degree of complexity of the control task and an undesirable error rate occurs due to the complexity of the process knowledge and because individual automation components and individual subprocesses are often changed.

### SUMMARY OF THE INVENTION

It is therefore an object of the present invention to simplify energy management for industrial automation arrangements and, in the case of changed automation components and subprocesses, to reliably take these changes into account.

This and other objects and advantages are achieved in accordance with the invention by holding (“encapsulating”) the production-related knowledge of the processes/subprocesses or system parts in a respective controlling automation component, and by accessing the automation component for the purpose of reducing the load using a standardized interface. A superordinate entity, such as a central control component or an energy management system, can thus use a standardized protocol and request acknowledgement and status messages that are configured to “negotiate” the further operational state with the individual automation components.

In accordance with an embodiment of the invention, an automation component is provided for an industrial automation arrangement, where the automation component is provided with at least one data interface for inputting control commands and for outputting status information or acknowledgement messages. Here, the automation component is configured to control alternate operation of at least two different operational states of a process, subprocess, device, or a system part controlled by the automation component, where the operational states have different power or energy consumptions, i.e., consumption of electrical power, of the process, subprocess, device or a system. Here, the automation component is configured to receive control commands containing requests to change over to one of the at least two different operational states, and is further configured to output acknowledgement messages in response to the requests. The automation component is also configured to output status messages relating to the activated operational state of the operational states. By configuring the automation component in this manner, it is possible to incorporate the automation component into a superordinate energy management system, where information relevant to energy management is readable from the automation component by evaluating the acknowledgement messages, and corresponding operational states are activateable or can be changed over by transmitting corresponding control commands for the automation component and the processes or subprocesses linked to this automation component.

The object of the invention is met by a method for activating one of a plurality of activatable operating states of a process, subprocess, device or system part controlled using an automation component, in an industrial automation arrangement. In accordance with the disclosed method, in a first step, the automation component receives a request message from a management entity to change an operational state of the system part, process or subprocess. In a second step, the automation component checks the status of the system part, process or subprocess controlled by the automation component to determine whether and for how long the requested change, activation or changeover of the operational state is permitted by predefined parameter limits of the system part, process or subprocess. In a third step, the automation component outputs this checking result to the management entity using an acknowledgement message and the changeover of the operational state is arranged depending on the checking result.

The method in accordance with the invention ensures that an automation component implements a command to change an operational state only when the system to be controlled, the process or the subprocess has those operating parameters which are not an obstacle to the change. The method also ensures that the superordinate entity is informed of the implementation or non-implementation of the request. In particular, the automation component itself can, thus, transmit to a superordinate entity information relating to whether, when and/or for how long a planned changeover or activation of an operational state is possible at the current moment in time.

The automation component is advantageously configured to receive a request relating to the switching-on, switching-off or partial load operation in the form of an operational state to be activated. The most frequently required operational states are therefore available for changeover. Here, the request for partial load operation advantageously includes either a statement relating to a relative reduction in the energy consumption of the process controlled by the automation component or a statement relating to an absolute reduction in the energy consumption of the process controlled by the automation component.

Acknowledgement messages from the automation component advantageously provide a superordinate entity with information relating to whether the request has been implemented in the form of a change of the operational state. Here, acknowledgement messages indicating that the changeover has been arranged but has not yet been implemented are also possible; the period of time until the changeover is advantageously transmitted with the acknowledgement message. In an embodiment, the acknowledgement message contains a statement relating to the amount of time for which the operational state that is activated can be maintained before a change to another operational state, usually the preceding operating state, is or must be automatically performed, provided that defined operating or process limits shall not be breached.

In another embodiment, the automation component is configured to advantageously emit a status message relating to the activated operational state for initializing a changeover operation and for general control purposes. Such a status message is advantageously emitted automatically after each change of the operating state.

A high degree of flexibility in the energy management of an automation arrangement thus occurs if an operational state with a maximum reduction in the energy consumption can be activated under the control of the automation component. Here, it is advantageous for an energy management system if the automation component is configured to emit an acknowledgement or status message relating to the relative or absolute reduction in the energy consumption which can be realized by a maximum reduction in the energy consumption and/or a statement relating to the maximum period of time until the system or process returns from this operational state to a previous operational state.

In another embodiment, the automation component is configured to emit a status message containing a list of all currently available operating states and/or all operating states that are actually provided. Consequently, a superordinate entity, such as an energy management system, can include system parts which have been recently switched on or recently added to the automation arrangement, and the automation components of the systems parts can be included in the energy management. Here, the list advantageously also specifies the respective values for the energy consumption or at least percentage (relative) values for the respective energy consumption.

In certain embodiments in which automation arrangements contain automation components from different manufacturers, the automation component is advantageously configured to process or output the request messages, acknowledgement messages and status messages, as well as the control commands in a standardized protocol. A changeover of the operational states that is matched to the process to be controlled or to the system to be controlled is thus facilitated if the automation component is configured to acquire and/or store information relating to the system part, process or subprocess, the automation component being configured to use this information relating to a decision regarding whether and for how long one or more of the operational states may be activated. The process knowledge of the downstream processes (i.e., subprocesses, devices, etc.) is thus encapsulated in the automation component. As a result, a superordinate entity, such as the energy management system, can generate and transmit adapted control commands, even without such process knowledge and solely by interchanging messages with the automation component. Here, messages are advantageously interchanged between the superordinate entity and the automation component by short messages in which individual bits (“flags”) are reserved for each of the standardized operational states.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the automation component according to the invention are explained below using the drawings. They are simultaneously used to explain a method according to the invention, in which:

FIG. 1 is a schematic block diagram of an automation arrangement having an energy supply, an energy management unit, a planning entity and subprocesses;

FIG. 2 is a schematic block diagram of an exemplary structure of messages with requests, acknowledgement messages and status messages;

FIG. 3 is an exemplary explanation of different bits (“flags”) in the messages of FIG. 2;

FIG. 4 shows a planning table of the planning entity of FIG. 1; and

FIG. 5 is a flow chart of the method in accordance with the invention.

### DETAILED DESCRIPTION OF THE PRESENTLY PREFERRED EMBODIMENTS

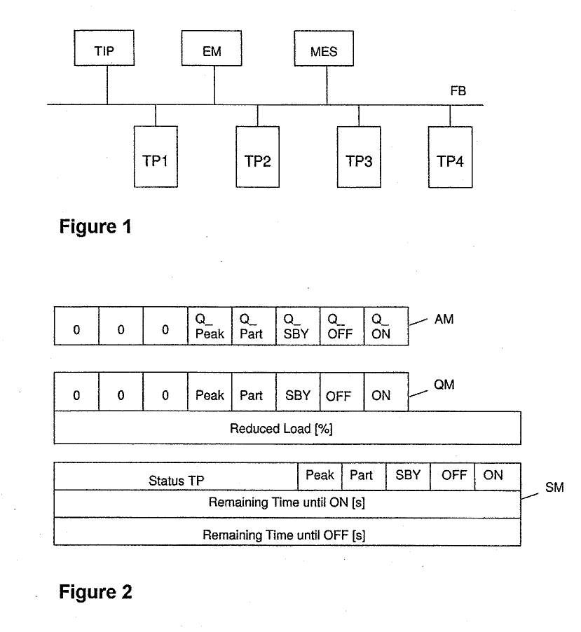

FIG. 1 shows a schematic block diagram of an industrial automation arrangement, such as a production system, in which automation components (TP1, . . . , TP4) (subprocesses) are arranged via a data network field bus system (FB), the automation components (TP1, . . . , TP4) each representing a subprocess to be controlled. Consequently, the respective subprocess is controlled by a respective automation component (TP1, . . . , TP4). In addition, the energy supply (Totally Integrated Power (TIP)), an energy management device (EM) and a planning entity (Manufacturing Execution System (MES)) are integrated in the automation arrangement using the data network FB and using an infrastructure (for example energy supply lines), which is not illustrated for purposes of clarity.

The energy management device (EM) comprises a control component for message-based interchange of control and state data relating to the settings of an energy-saving profile integrated in the automation components (TP1, . . . , TP4). This energy-saving profile comprises a set of different and, preferably, standardized operating states, where the standardization in the present exemplary embodiment relates to the operating states themselves, and to the message-based or register-based control related to the operating states. In the present exemplary embodiment, the control component (not illustrated) may be integrated inside the energy management device (EM) in the form of software or a software plug-in. Alternatively, the control component is integrated in other components, i.e., in the energy supply (TIP) or in the planning entity (MES).

As discussed below, it shall be assumed, by way of example, that the automation component (TP1) controls, as a subprocess, a compressor which fills a compressed air storage container which is important for the production system. Here, the intention is to use the control properties of the automation component (TP1) to maintain the pressure of this storage container between a minimum value and a maximum value. For this purpose, the rotational speed of the compressor can be controlled. As a result, its pumping capacity and, thus, its energy consumption (consumption of electrical power from the energy supply (TIP)) can be continuously controlled.

The energy supply (TIP) continuously monitors the electrical power consumed by the entire production system, and continuously provides the energy management unit (EM) and, thus, the plug-in containing the control component with this value via the data network (FB). Furthermore, the planning entity (MES) supplies the energy management unit (EM) with planning data relating to production of the production system likewise via the data network (FB); such planning data are illustrated by way of example in FIG. 4.

Alternatively, it is also possible to consider the energy consumption of fewer subprocesses or else of only a single subprocess; this presupposes the existence of appropriately differentiated measuring devices. In a further, alternative exemplary embodiment, the current, the minimum and/or the maximum energy consumption of a subprocess can also be read from the corresponding automation component (TP1, . . . , TP4) using interrogation messages; this makes it possible to save measuring means.

The energy management unit (EM) is configured such that, in cases in which the electrical power consumed by the production system or the partial production system in question approaches or exceeds a first limit value, the power of those processes and subprocesses which do not have to be continuously operated with a uniform load is intended to be stepped down. This is the case with the compressor which is controlled by the automation component (TP1). If the pressure in its storage container is above the minimum pressure, the delivery rate of the compressor and, thus, its energy consumption can be reduced or even switched off entirely. In order to achieve this, the energy management unit (EM) communicates with the automation component (TP1) using a standardized protocol. For this purpose, the energy management unit (EM) sends a standardized message, i.e., the request message (AM), to the automation component (TP1).

FIG. 2 is a schematic block diagram of an exemplary structure of the request messages (AM), the acknowledgement messages (QM) and the status messages (SM). In simplest form, the payload of the request message (AM) comprises only one byte in which the bit with the designation “Q_Part” is intended to cause the automation component (TP1) or the subprocess controlled by the automation component (TP1) to be changed to an operating state which corresponds to partial load operation (“Part”). In an embodiment, the request message (AM) may also comprise two further bytes (not illustrated) which specify a percentage value for the desired load reduction; it is alternatively also possible to work with absolute values. The automation component (TP1) responds with an acknowledgement message (QM) which is likewise diagrammatically illustrated in FIG. 2, and preferably provides information relating to the implementation or non-implementation of the request message (AM) likewise by setting individual bits in a standardized manner. In accordance with the presently contemplated embodiment, the fourth bit “Part” is set in this acknowledgement message (QM). As a result, the automation component (TP1) confirms the changeover to partial load operation of the compressor. In two further bytes, the acknowledgement messages (QM) also provide information relating to the percentage by which the consumed power could be reduced, for example, 50%. Furthermore, temporal statements relating to the changeover can be made using the acknowledgement message (QM) or, like here, by using a separate status message (SM). The period of time until the changeover (“remaining time until on”) is thus set to zero in the present case because the changeover has already occurred. The relapse time (“remaining time until off”) is that amount of time which is predicted by the automation component (TP1) and will elapse before the operating state is changed again (here: to full load operation). For this purpose, the automation component (TP1) not only checks, before the changeover to partial load operation, whether the pressure of the pressure vessel is above the minimum limit but also takes into account the pressure gradient (e.g., the pressure drop per unit time) to calculate when the minimum pressure will be reached with the current reduced delivery rate of the compressor. These measures prevent the reduction in the energy consumption of the subprocess, as required by the energy management unit (EM), resulting in an unwanted state (here: reduced pressure).

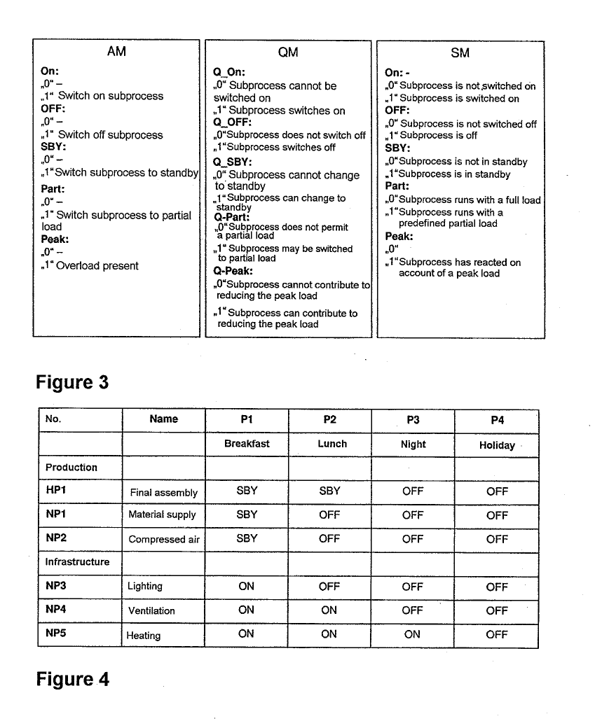

FIG. 3 is an exemplary explanation of different bits (“flags”) in the messages of FIG. 2. That is, FIG. 3 is a table providing the meanings of the individual bits in the messages of FIG. 2. It should be understood that other conventions relating to the interchange of messages, i.e., text-based or variable-based instructions, may also be implemented. In particular, information need not be transported between the energy management unit (EM) and automation components (TP1, . . . , TP4) using messages at all but, rather, the corresponding data words (bytes) may also be stored in a common database or in another information memory such that they can each be accessed or at least read. This applies, in particular, to so-called “global variables” of the production process.

Instead of the percentage load specifications described, it is also possible to use absolute values, for example, in the unit “kilowatts”, in particular for the electrical power saved.

FIG. 4 shows a planning table of the planning entity of FIG. 1. That is FIG. 4 illustrates, by way of example, product planning of the planning entity (MES) in the form of a table. Such planning data are advantageously used by the energy management unit (EM) to perform prioritization when transmitting request messages (AM). That is, not only are the rigid specifications from these tables (for example the switching-off of lighting in operating pauses) implemented using the request message (AM) sent by the energy management unit (EM) but processes such as the exemplary pressure accumulator are changed over to the “full load” operational state, for example, in operational pauses in which the total consumption of electrical power is already low, in order to again be ready with a maximum supply of compressed air following the operational pause to relieve the load on the energy supply (TIP). The energy management unit (EM) can control a multiplicity of automation components (TP1, . . . , TP4) and the associated subprocesses. Consequently, the energy management unit (EM) can accurately and globally negotiate the saving in the necessary energy consumption or can contribute to temporally leveling out the energy consumption. The “overload” (e.g., “peak”) operational state in which the respective automation component is requested to immediately “shed” a maximum load contributes to this, in particular. In the case of this exemplary compressor, the latter is switched off completely until a minimum pressure has been reached.

The automation component (TP1, . . . , TP4) is advantageously configured to transmit a list (not shown) containing all available operational states (e.g., on, off, standby, partial load or full load) using a special status message (SM), where this list optionally comprises statements regarding an average reaction time needed to switch on the respective operational state. In particular, devices recently integrated in the production system can thus be automatically taken into account by the energy management unit (EM). Status messages (SM) can be transmitted either on request or automatically by the respective automation component (TP1, . . . , TP4). Automatic transmission is performed, in particular, when an operating state of the respective automation component (TP1, . . . , TP4) has changed. Here, it is also possible to set automatic transmission in defined intervals of time.

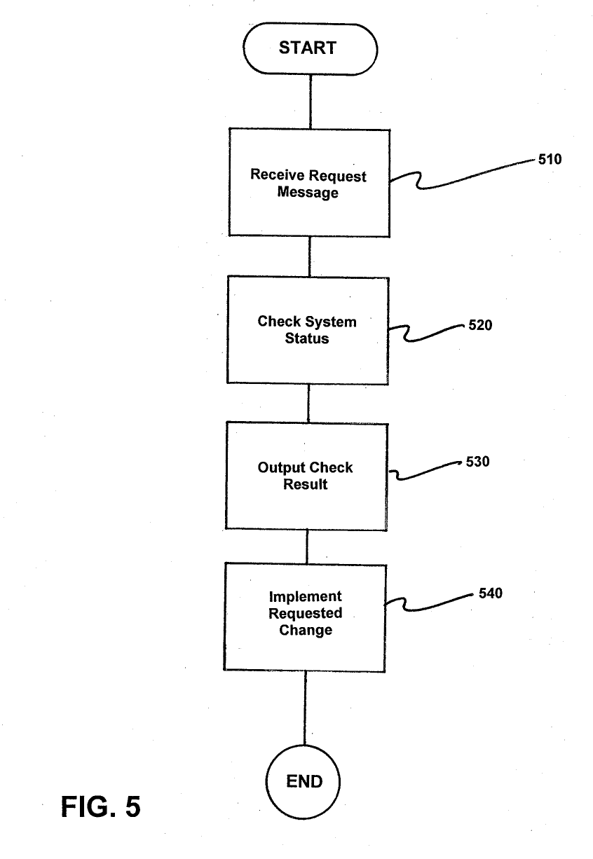

FIG. 5 is a flow chart illustrating the steps of a method for activating one of a plurality of activatable operating states of a system part, process or subprocess controlled by an automation component in an industrial automation arrangement in accordance with the invention. As shown in FIG. 5, a request message from a management entity to change an operational state of the system part, process or subprocess is received at the automation component, as indicated in step 510.

A check of the status of the system part, process or subprocess that is controlled by the automation component is performed at the automation component to determine whether the received request to change the operational state of the system part, process or subprocess is permitted by predefined parameter limits of the system part, process or subprocess, as indicated in step 520. The result of the check is output from the automation component to the management entity using an acknowledgement message, as indicated in step 530. Next, the requested change of the operational state is implemented at the automation component depending on the checking result.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. An automation component for an industrial automation arrangement, the automation component being configured to control at least one system part, process or subprocess of the industrial automation arrangement, at least two different operating states being alternately settable for the at least one system part, process or subprocess, and the operating states differing with respect to power consumption of the system part, process or subprocess,
wherein the automation component is configured to receive from a communication means of the industrial automation arrangement requests to change over to one of the at least two different operational states;
wherein the automation component is configured to output acknowledgement messages in response to the received requests; and
wherein the automation component is configured to output status messages relating to an activated operational state of the at least one system part, process or subprocess.

2. The automation component as claimed in claim 1, wherein the automation component is configured to decide, in response to the received request, whether a required changeover can be implemented, the automation component being configured such that the changeover is performed and a positive acknowledgement message is output in cases of a positive acknowledgement and a negative acknowledgement message is output in cases of a negative acknowledgement.

3. The automation component as claimed in claim 1, wherein the operational states to be changed over include at least one of switched-on, switched-off and partial load operation of the at least one system part, process or subprocess.

4. The automation component as claimed in claim 3, wherein the request for partial load operation includes a statement indicating a relative or absolute reduction of energy consumption.

5. The automation component as claimed in claim 1, wherein the operational states to be changed over comprise an operational state having a maximum reduction of energy consumption.

6. The automation component as claimed in claim 2, wherein the acknowledgement message includes a statement relating to when the operational state is changed over, as requested by the received request, or when the operational state is activated.

7. The automation component as claimed in claim 2, wherein the acknowledgement message includes a statement relating to a maximum possible duration of the operational state requested by the received request message.

8. The automation component as claimed in claim 2, wherein the automation component is configured to emit a status message relating to a relative or absolute reduction of the energy consumption which is realizable by a maximum reduction of energy consumption.

9. The automation component as claimed in claim 1, wherein the automation component is configured to emit an information message containing at least one of a list of all currently available operational states of the at least one system part, process or subprocess and all operational states of the at least one system part, process or subprocess which are actually provided.

10. The automation component as claimed in claim 1, wherein the automation component is configured to evaluate incoming request messages and to output acknowledgement and status messages using a standardized protocol.

11. The automation component as claimed in claim 10, wherein the standardized protocol provides at least one reserved bit in a data word for each operational state.

12. The automation component as claimed in claim 1, wherein the automation component is configured to at least one of acquire and store information relating to the at least one system part, the process or subprocess, the automation component being configured to use the stored information to decide whether and for how long at least one operational state may be activated.

13. A method for activating one of a plurality of activatable operating states of a system part, process or subprocess controlled by an automation component in an industrial automation arrangement, comprising:
receiving, at the automation component, a request message from a management entity to change an operational state of the system part, process or subprocess;
checking, at the automation component, a status of the system part, process or subprocess controlled by the automation component to determine whether the received request to change the operational state of the system part, process or subprocess is permitted by predefined parameter limits of the system part, process or subprocess;
outputting, from the automation component, a result of the checking to the management entity using an acknowledgement message; and
implementing, at the automation component, the requested change of the operational state depending on the checking result.

14. The method as claimed in claim 13, wherein said step of checking comprise checking a status of the system part, process or subprocess controlled by the automation component to determine how long the requested change of the operational state is permitted by the predefined parameter limits of the system part, process or subprocess.

15. The method as claimed in claim 13, wherein said checking step comprises checking the status of the system part, process or subprocess controlled by the automation component to determine how much time is required for the requested change of the operational state.

16. The method as claimed in claim 14, wherein said checking step comprises checking the status of the system part, process or subprocess controlled by the automation component to determine how much time is required for the requested change of the operational state.
